(19) United States
(12) Patent Application Publication
(10) Pub. No.: US 2026/0298448 A1
(43) Pub. Date: Oct. 1, 2026

(54) Luminaire

(71) Applicant: BEGA Gantenbrink-Leuchten KG, Menden (DE)

(72) Inventor: Michael Golew, Iserlohn (DE)

(73) Assignee: BEGA Gantenbrink-Leuchten KG, Menden (DE)

(21) Appl. No.: 19/632,592

(22) Filed: Mar. 30, 2026

(30) Foreign Application Priority Data
Mar. 31, 2025 (LU) LU600960

(51) Int. Cl. F21V 17/16; F21S 8/04; F21V 15/01; F21V 17/18; F21V 23/00; F21Y 115/10

(52) U.S. Cl. CPC F21V 17/164; F21S 8/046; F21V 15/01; F21V 17/18; F21V 23/002; F21V 23/005; F21Y 2115/10

(57) ABSTRACT

A luminaire (1) includes a multi-part housing (2, 3) as well as a plurality of functionally relevant components (4, 5, 6, 7). Several of the functionally relevant components (4, 5, 6, 7) have engagement elements (8) which can be mechanically connected to corresponding retaining elements (9) of the housing (2, 3) and can thereby be fixed in a defined position by a mechanical engagement.

### CROSS-REFERENCE TO RELATED APPLICATION

This application claims the benefit of Luxembourg Patent Application LU600960, filed on Mar. 31, 2025, the entire contents of which is incorporated by reference.

### TECHNICAL FIELD

The disclosure relates to a luminaire having a multi-part housing and functionally relevant components fixed therein in a positionally stable manner.

### BACKGROUND

In practice, luminaires are typically of modular design: an LED board is inserted into a holding or cooling structure, followed by an optical unit—consisting of a lens or cover—followed by a housing that protects and mechanically fixes these elements. The electrical connection is supplemented by a connection cable with strain relief. In series production as well as in service use, assembly of these components is usually carried out by screws, plug-in connections, latching mechanisms or clampings often in combination.

In particular, the mechanical fastening in known solutions is predominantly carried out by screws or separate holding elements. For example, EP 3339724 B1 shows a luminaire with a carrier rail in which LED modules are fastened via separate holders with latching lugs. The other housing components—such as optical components or cable inlets—however remain screwed or are conventionally joined.

EP 2873913 B1 also describes a snap connection of a cover onto a luminaire housing, but uses additional components and does not permit complete disassembly. The same applies to U.S. Pat. No. 10,251,279 B1, in which latching structures for fixing a board are described, but no complete overall concept of a luminaire without screws is disclosed.

### SUMMARY

The disclosure is based on the object of providing a luminaire in which all functional assemblies can be mounted without screws or detachable additional components. The object is achieved by the luminaire as disclosed and claimed.

A luminaire is provided which comprises a multi-part housing and a plurality of functionally relevant components, wherein several of these components each have at least one engagement element which can be connected, by mechanical engagement, to a corresponding retaining element provided on the housing. By engagement between the engagement element and the retaining element, each of these components can be fixed in a defined position relative to the housing. The connection can in particular be realized by a form-fitting connection, a force-fitting connection, or a combination of both mechanisms.

A substantial advantage of this embodiment lies in the tool-less and assembly-friendly fixing of the components within the luminaire. Since no additional fastening means are required, the material and assembly effort is reduced considerably. In addition, the defined positioning enables high repeat accuracy, which is significant in particular for optical or heat-conducting components. The modular design favors simple adaptation of the luminaire to different application scenarios or product variants.

In one embodiment, the respective engagement element and the corresponding retaining element are geometrically designed such that, when inserting the respective component, a mechanical retaining connection is produced without additional fastening means such as screws, clamps or external clips being required. The engagement occurs in particular by a controlled elastic deformation of the components, for example when passing over a latching projection or when inserting into a receptacle with an undercut.

A substantial advantage of this construction consists in that all functionally relevant components of the luminaire—for example an LED board, an optical unit, a tube, or similar elements—can be received directly in the housing. The tool-less and screwless connection considerably simplifies assembly, reduces the number of individual parts, and lowers manufacturing costs.

In a preferred embodiment, the luminaire comprises, as functionally relevant components, at least an electronic board, an optical unit with lens or cover, and a tube. Further components can be advantageous. The electronic board typically serves as a carrier for illuminants such as light-emitting diodes (LEDs) and, if applicable, for further electronic functional units, for example for actuation, regulation or power supply. The optical unit, for example in the form of a lens, lens with retaining ring, or a cover, performs the light-guiding or light-scattering function and defines the radiation characteristics of the luminaire. The tube can be designed as an optical, thermal or mechanical component and serves, for example, for optical shielding, spacing, or as a carrier for further components. The positioning and fixing of the elements within the housing parts takes place exclusively via structurally defined retaining elements and elastically deformable fastening regions, whereby the entire luminaire structure can be realized without additional mechanical connecting means.

In a preferred further development, the engagement elements of the functionally relevant components and the corresponding retaining elements of the housing are designed as a form-fitting connection. Mechanical fixing is effected by geometrically complementary structures which prevent mutual displacement or rotation of the components relative to the housing. For example, the functionally relevant components can have, at their edge regions, projections or latching tongues which latch into associated undercuts or latching openings designed as retaining elements in the housing. Furthermore, the engagement elements can be connected in a form-fitting manner to a housing part via cylindrical guides or circumferential latching edges. In addition, the functionally relevant components can, for example, have projections or bayonet-like lugs which are inserted into associated slots or grooves in the housing, so that a position secure against rotation and secured axially can be achieved. These form-fitting connections allow tool-less and repeat-accurate assembly of the luminaire components while at the same time providing high mechanical stability.

In a further preferred embodiment, the engagement elements of the functionally relevant components can be designed as plug-in, snap or latching elements. These can, for example, be designed as resilient tongues, latching lugs or profiled projections, which are elastically deformed when inserting the respective component into the housing and then latch into a corresponding geometry. The associated retaining elements of the housing comprise for this purpose at least one plug-in, snap or latching surface, with which the engagement elements can be brought into functional operative contact. The connection between the components and the housing is preferably effected by form fit and can be configured such that an axially or radially directed fixing is achieved.

It is advantageous that the retaining elements of the housing are designed as plug-in, snap or latching elements. These can, for example, be designed as elastically yielding latching lugs, snap hooks or projecting locking structures which are deformed when inserting the component and, after passing a retention point, snap back into their initial position. In this embodiment, the engagement elements of the functionally relevant components have at least one associated plug-in, snap or latching surface which can be brought into functional operative contact with the retaining elements. By the geometry designed in this way, a defined fixing, preferably form-fitting, can be achieved, which enables repeat-accurate positioning as well as tool-less assembly and disassembly of the components.

It is advantageously provided that the retaining element is designed as a structured receptacle in a housing part. The structured receptacle can have different geometries which are designed to receive a plug-in, snap or latching element of the respective component. In particular, grooves, slots, through-openings, bores, recesses, undercuts or latching chambers are considered as embodiments. Combinations of these structural elements are also possible in order to ensure reliable guidance, retaining action or latching of the engagement elements. Due to the structured design of the retaining element, the respective component can be positioned in a defined position in the housing in a targeted manner and secured against rotation or displacement.

In a further preferred embodiment, the engagement elements are designed as an elastically deformable fastening region, in particular as a latching tongue, tab, web or resilient projection. These elements are an integral constituent of the respective component and are designed such that they are elastically deflected when inserted into the associated retaining element of a housing part. Of course, it can also be provided that the retaining elements are designed as an elastically deformable fastening region. After overcoming a latching edge or an undercut, at least partial return of the fastening region into its original position occurs, whereby a defined engagement with the retaining element is produced. The use of such elastically resilient structures enables purely mechanical self-locking of the component in the housing—without separate spring elements or additional connecting means. The elastic deformability makes it possible to compensate tolerances and at the same time provides a force-fitting or form-fitting retaining action, depending on the embodiment of the latching contour. In addition, such elastic structures can be efficiently integrated into the respective component in a single manufacturing process—e.g. by injection molding, stamping or milling—thereby improving manufacturability.

In one embodiment, it is provided that the engagement elements are arranged at an edge region or at opposite sides of a functionally relevant component. In particular, it is provided that the engagement elements are present uniformly distributed over the circumference of the respective components. By placement in edge zones, the fastening structures can be designed without impairing the functional surface or the electrical contacting. In the case of an arrangement on both sides, symmetrical fixing is made possible, which supports a centered and position-secured positioning within the housing.

An opposite arrangement of the engagement elements is also particularly suitable for latching connections in which the component is introduced, by a linear movement, into the retaining elements of the housing designed as structured receptacles. The elastic engagement at several points distributes the mechanical retaining forces uniformly and increases assembly reliability. At the same time, this configuration enables controlled disassembly, since the component can be released in a targeted manner via the latching points on both sides.

It is preferred that the retaining element is designed as a structured receptacle in a housing part. The structured receptacle can in this case have different geometries, in particular in the form of a groove, slot, a through-opening, a bore, a recess, an undercut, a latching chamber, or as combinations thereof. These geometries form defined counterpart structures to the engagement elements of the functionally relevant components and serve for targeted engagement thereof. The design as an undercut or latching chamber allows, for example, form-fitting locking after insertion. Grooves, slots or through-openings can additionally ensure linear guidance or support of the component. Combinations—such as a slot with an integrated latching edge—are also realizable and enable a particularly stable and assembly-friendly connection. The structured receptacles can be manufactured in a material-efficient manner and can be adapted in production engineering terms easily to different luminaire designs. As a result, the disclosure is also suitable for modular or variant-rich luminaire assemblies.

It is advantageous that the retaining element has a latching lug or a snap projection, over which the elastically deformable fastening region of a functionally relevant component is guided during insertion and behind which it returns into engagement position. The latching lug or the snap projection is in this case structurally designed such that it represents a defined overcoming threshold for the fastening region, wherein the fastening region is elastically deformed during insertion and, after passing the latching point, transitions into a latched position due to its restoring force. By the latching geometry, a reliable form fit is achieved, which fixes the component in the housing in a position-secured manner. At the same time, the elastic restoring movement of the fastening region enables automatic latching without additional securing elements. A further advantage lies in the clearly defined installation and end position, which ensures repeat-accurate assembly and thus a reproducible alignment of the components—especially in the case of optically effective elements.

It is advantageously provided that the housing of the luminaire is designed in two parts and consists of a first and a second housing part. At least one of the two housing parts has at least one retaining element which serves for engagement with at least one engagement element of a functionally relevant component. The two housing parts can be connected to one another, in particular by a plug-in, latching or snap connection. This design allows a particularly compact and assembly-friendly construction of the luminaire. The two-part housing concept makes it possible to first insert the functionally relevant components—such as, for example, a board, a lens or a tube—into one of the housing parts and subsequently close or lock by the second housing part. The connection of the two housing parts is in this case tool-less, fast and without the use of separate fastening means such as screws or clamps. The housing parts can advantageously consist of a plastic and can be provided, for example, by an injection-molding process.

In a further advantageous embodiment, a strain relief for an electrical connection cable is realized in that the cable is held in a clamping manner between at least one functionally relevant component and at least one housing part. The clamping action arises here due to the constructive interaction of two components, for example by inserting the connection cable into an intermediate space which forms a defined clamping region when the components are joined together. In contrast to conventional solutions, in which separate strain-relief elements or screw clamps are required, the strain relief in this embodiment is completely integrated into the geometry of the luminaire. The function results solely from the structured design of the components involved, without additional components or assembly steps being necessary. A substantial advantage of this solution consists in the reduction of the number of parts and the assembly effort. The clamping action is reliably reproducible and prevents pulling out or movement of the connection cable under mechanical load. At the same time, the connection remains releasable, which is advantageous in particular for maintenance or service purposes.

In a further advantageous embodiment it is provided that the housing parts and the functionally relevant components are arranged relative to one another such that, during assembly, they can be inserted successively into the housing along a common insertion direction. The insertion direction can, for example, be oriented linearly, axially or obliquely relative to the housing axis and is matched to the position of the structured retaining elements and the associated fastening regions. This arrangement makes it possible to introduce all components of the luminaire—for instance the LED board, optical units, tube or cover—sequentially in a defined sequence into the housing. The geometric guidance by the retaining elements ensures a self-centering, position-secured positioning of the individual components. Due to the common direction of the insertion movement, assembly is simplified and at the same time accelerated.

It is preferred that the geometry of the retaining element and/or of the engagement element is designed such that disassembly is possible without destruction by manual deflection or targeted releasing of the connection. This means that the functionally relevant component can be removed from its retaining position without the geometry being permanently damaged or the retaining element becoming unusable. The design of the connection can, for example, be such that the latching force can be overcome by slightly deflecting an engagement element by pressure or tension and thereby guiding it out of engagement with the retaining element. Alternatively or additionally, the retaining element itself can also have an elastically yielding structure which allows releasing by bending load or reduction of prestress.

In a preferred embodiment, a receiving ring is provided which is present as a constituent of the functionally relevant components and at least partially supports at least one further functionally relevant component. The receiving ring can, for example, be designed as a rotationally symmetrical or polygonal component and forms a base structure for the mechanical fixing and mounting of further luminaire components such as, for example, an LED board, a light-guiding unit or a tube. The supporting function of the receiving ring can be realized both by planar support and by retaining geometries such as latching contours, guide slots or receiving pockets. The receiving ring is advantageously designed such that it itself has engagement elements and can be connected to other housing parts in a form-fitting or force-fitting manner.

In a further preferred embodiment, additional functionally relevant components of the luminaire are connected directly to one another, without needing to be fixed via retaining elements of the housing. The connection of these components is in this case effected by form fit, force fit or a combination of both principles. Possible embodiments comprise, for example, plugging one component onto another, placing a component into an associated fit structure, or inserting two elements into one another with complementary geometries. In this way, certain subassemblies, such as a lens with a tube or a cover with an optical unit, can be joined in an assembly-friendly manner and without additional fastening means, whereby the overall structure of the luminaire can be further simplified.

In an alternative embodiment, a mounting bracket is provided which can be fitted on an outer surface of the housing and serves to fasten the luminaire to a ceiling or wall structure. The mounting bracket can, for example, be designed as an elastically resilient element, as a wire bracket, sheet-metal tab or as a molded plastic part and serves for mechanical attachment of the luminaire to an on-site retaining construction. The fitting of the bracket on the luminaire is preferably effected via structured housing sections, for example by latching receptacles, plug-in connections or guide channels, so that tool-less assembly or retrofitting is possible. The fastening can in this case be designed to be reversible.

A substantial advantage of this embodiment lies in the decoupling of the housing and installation function. The luminaire can be completely preassembled and, for installation, only has to be connected to the building structure via the mounting bracket. This considerably facilitates installation, in particular in the case of recessed ceiling luminaires, pendant or surface-mounted applications. In addition, the mounting bracket enables a defined introduction of force and provides scope for tolerance compensation, for example in the case of uneven substrates.

Further advantageous embodiments are explained in more detail using exemplary embodiments shown in the drawing.

### BRIEF DESCRIPTION OF THE DRAWINGS

FIG. 1 shows a perspective exploded view of a first exemplary embodiment of a luminaire,

FIG. 2 shows a perspective exploded view of a further exemplary embodiment of a luminaire,

FIG. 3 shows a perspective top view of a receiving ring,

FIG. 4 shows a perspective top view of an LED holder, and

FIG. 5 shows a perspective view of a luminaire with one housing part and components fastened thereto.

### DETAILED DESCRIPTION

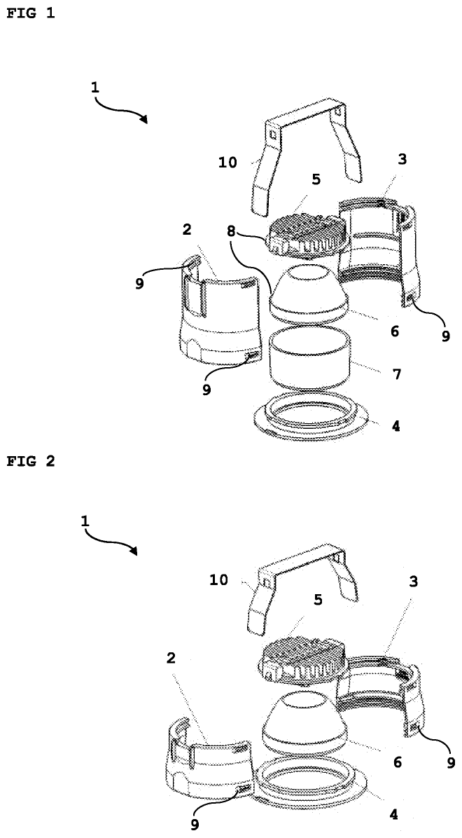

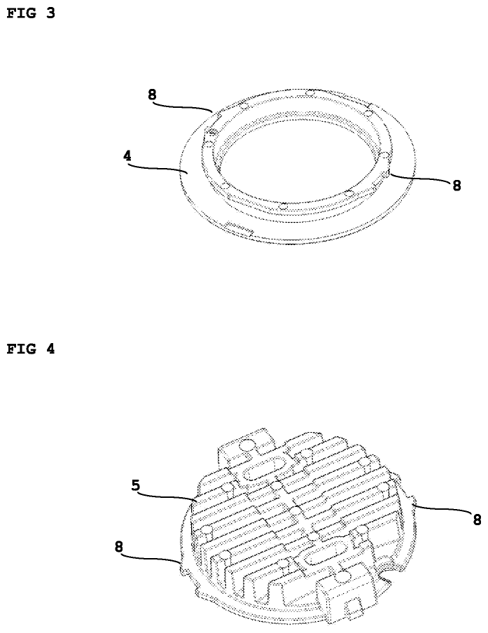

In a preferred embodiment according to FIG. 1 and FIG. 2, a luminaire 1 is provided, which comprises a multi-part housing 2, 3. The housing 2, 3 consists of a first housing part 2 and a second, corresponding housing part 3. Arranged between the housing parts 2, 3 are multiple functionally relevant components, including a receiving ring 4 which serves as a lower carrier structure, an LED holder 5 which supports an electronic board, an optical unit 6 with lens or cover, and a tube 7 which performs optical functions and is suitable for receiving or guiding further components. The receiving ring 4 is shown separately in FIG. 3 and the LED holder 5 in FIG. 4.

Several of said components—particularly the receiving ring 4, the LED holder 5 and the tube 7—have at least one engagement element 8 which can be brought into mechanical engagement with a retaining element 9 provided on the housing 2, 3. The engagement elements 8 can, for example, be designed as latching lugs, snap projections or resilient tabs, which are elastically deflected during insertion and, after overcoming a latching contour, snap behind an associated retaining element 9. In this way, a form-fitting and/or force-fitting connection is achieved, by which the respective component is positioned and fixed on the housing in a defined position. Other fastening means such as screws, clips or the like are not necessary.

Individual functionally relevant components—such as the optical unit 6—can alternatively be connected directly to another component, for example the tube 7. Such connections are preferably effected by form fit, force fit or a combination of both principles, for example by plugging on, placing in or inserting into one another, and do not require retaining elements on the housing 2, 3.

An electrical connection cable (not shown) which is connected to the board arranged on the LED holder 5 can be received in a clamping manner between the latter and the first housing part 2. By this arrangement, a functional strain relief is produced, without a separate strain-relief element being required.

For fastening the luminaire 1 to a ceiling or wall structure, a mounting bracket 10 is provided which is fitted on an outer surface of the housing 2, 3. The mounting bracket 10 is elastically resilient and enables simple, tool-less installation at the place of use.

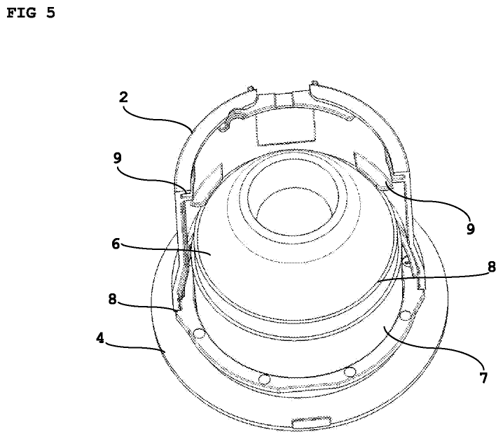

As can be seen clearly in FIG. 5, assembly of the luminaire 1 can preferably take place along a common insertion direction, which in the exemplary embodiment shown is oriented axially. The components can in this case be inserted successively in a defined sequence, whereby a process-reliable and tool-less assembly is realized which is also suitable for automated manufacturing processes. In this case, the receiving ring 4 supports the tube 7 and the optical unit 6 in the form of a lens. The receiving ring 4 is reversibly fastened to a housing part 2 with corresponding engagement elements 8. The optical unit 6 is placed on the tube 7 and can comprise circumferential engagement elements 8 which can be brought into engagement with retaining elements 9 on the housing part 2, 3. The tube 7 can be held on the receiving ring 4 in a form-fitting manner.

The luminaire 1 is overall constructed such that its functionally relevant components can be assembled and disassembled without additional fastening means such as screws or clamps. Mechanical fixing is effected exclusively via the interaction of engagement elements 8 and retaining elements 9 as well as via directly acting connection mechanisms between individual components. This enables a particularly compact, maintenance-friendly and cost-efficient construction with a high degree of integration.

### LIST OF REFERENCE SIGNS

1. Luminaire
2. First housing part
3. Second housing part
4. Receiving ring
5. LED holder
6. Optical unit
7. Tube
8. Engagement element
9. Retaining element in the housing
10. Mounting bracket

What is claimed is:

1. A luminaire (1), comprising:
a housing comprising two housing parts (2,3), including a first housing part (2) and a second housing part (3); and
a plurality of components (4, 5, 6, 7),
wherein at least some of the components (4, 5, 6, 7) comprise engagement elements (8) configured to mechanically engage corresponding retaining elements (9) of the housing (2, 3) to fix the components (4, 5, 6, 7) in a predetermined position relative to the housing (2, 3).

2. The luminaire (1) of claim 1,
wherein the components (4, 5, 6, 7) comprise:
an electronic board;
an optical unit (6) with lens or cover; and
a tube (7).

3. The luminaire (1) of claim 1,
wherein the engagement elements (8) and retaining elements (9) are configured to mechanically interlock.

4. The luminaire (1) of claim 1,
wherein the engagement elements (8), the retaining elements (9), or both are configured as plug-in, snap-fit, or latching elements, each comprising at least one surface configured to mechanically engage a corresponding element to retain the components (4, 5, 6, 7) in the predetermined position.

5. The luminaire (1) of claim 4,
wherein the retaining elements (9) include a receptacle formed in at least one of the two housing parts (2, 3), the receptacle comprising a groove, a slot, a through-opening, a bore, a recess, an undercut, or a latching chamber.

6. The luminaire (1) of claim 1,
wherein the engagement elements (8) are configured as an elastically deformable fastening portion.

7. The luminaire (1) of claim 6,
wherein the retaining elements (9) comprises a latching lug or a snap projection, and the elastically deformable fastening portion (8) is configured to be deflected over the latching lug or the snap projection during insertion and to elastically return to engage the latching lug or the snap projection when inserted.

8. The luminaire (1) of claim 1,
wherein the engagement elements (8) are uniformly distributed along a circumference of at least one of the components (4, 5, 6, 7).

9. The luminaire (1) of claim 1,
wherein the retaining elements (9) are provided in at least one of the two housing parts (2, 3), and
wherein the first housing part (2) is connected to the second housing part (3) by a plug-in connection, a latching connection, or a snap-fit connection.

10. The luminaire (1) of claim 1,
wherein a strain relief for an electrical cable is provided by clamping the electrical cable between at least one of the components (4, 5, 6, 7) and at least one of the two housing parts (2, 3).

11. The luminaire (1) of claim 1,
wherein the two housing parts (2, 3) and the components (4, 5, 6, 7) are arranged such that they are insertable successively along a common insertion direction.

12. The luminaire (1) of claim 1,
wherein a receiving ring (4) is one of the components (4, 5, 6, 7), and the receiving ring (4) at least partially supports at least another one of the components (5, 6, 7).

13. The luminaire (1) of claim 1,
wherein at least some of the components (4, 5, 6, 7) are directly connected to one another by mechanical interlocking, frictional engagement, or a combination thereof.

14. The luminaire (1) of claim 1,
further comprising a mounting bracket (10) mounted on an outer surface of the housing and configured to fasten the luminaire (1) to a ceiling or a wall.
